(19) United States
(12) Patent Application Publication
(10) Pub. No.: US 2022/0141577 A1
(43) Pub. Date: May 5, 2022

(54) PORTABLE INSTRUMENT AMPLIFICATION SYSTEM WITH PASSIVE RADIATORS

(71) Applicant: LowTone Music, Bellevue, WA (US)

(72) Inventor: John Ellis, Bellevue, WA (US)

(73) Assignee: LowTone Music, Bellevue, WA (US)

(21) Appl. No.: 17/516,028

(22) Filed: Nov. 1, 2021

Related U.S. Application Data
(60) Provisional application No. 63/108,785, filed on Nov. 2, 2020.

(51) Int. Cl. H04R 1/34; H04R 1/02

(52) U.S. Cl. CPC H04R 1/345; H04R 2201/34; H04R 1/02

(57) ABSTRACT

A portable instrument amplification system includes a cabinet having a top cabinet member, a bottom cabinet member, and a plurality of side cabinet members. The portable instrument amplification system also includes at least one sealed chamber having a front chamber member, a side chamber member, a rear chamber member, at least one speaker driver, at least one side passive radiator, and at least one cabinet bracing secured in at least one corner of the sealed chamber. The cabinet bracing includes a cabinet bracing body, and at least one stiffener attached to the cabinet bracing body. The portable instrument amplification system also includes at least one front-facing port having a rear port member vertically attached between the side chamber member and a second side cabinet member behind the at least one side passive radiator, and a bass phase plug vertically disposed facing the at least one side passive radiator.

This application claims the benefit of U.S. Provisional patent application Ser. No. 63/108,785, filed on Nov. 2, 2020, the contents of which are incorporated herein by reference in their entirety.

### BACKGROUND

Conventional speaker cabinet construction produces speaker cabinets that are heavy and made with thick plywood or particle board with minimal bracing. These speaker cabinets are cumbersome due to their weight. However, attempts to reduce the weight of the construction may come at the cost of the acoustics of the speakers, or may necessitate the use of expensive material compounds that greatly reduce the practicality of such speakers for the existing market, in terms of manufacturability and price. Therefore, a need exists for an improvement that reduces weight without negatively impacting the sound produced by the speakers or substantially increasing manufacturing costs and complexity.

### BRIEF SUMMARY

In one aspect, a portable instrument amplification system includes a cabinet including a top cabinet member, a bottom cabinet member, and a plurality of side cabinet members. The portable instrument amplification system also includes at least one sealed chamber, the sealed chamber includes a front chamber member, a side chamber member, a rear chamber member, at least one speaker driver, at least one side passive radiator, and at least one cabinet bracing secured in at least one corner formed by the front chamber member and a first side cabinet member, the first side cabinet member and the rear chamber member, the rear chamber member and the side chamber member, and the side chamber member and the front chamber member. The cabinet bracing includes a cabinet bracing body, and at least one stiffener attached to the cabinet bracing body. The portable instrument amplification system also includes at least one front-facing port. The front-facing port includes a rear port member vertically attached between the side chamber member and a second side cabinet member behind the at least one side passive radiator, and at least one bass phase plug vertically disposed facing the at least one side passive radiator. The at least one bass phase plug comprises one of the second side cabinet member and a standalone bass phase plug.

In one aspect, the portable instrument amplification system includes a cabinet including a top cabinet member, a bottom cabinet member, and a plurality of side cabinet members. The portable instrument amplification system also includes two sealed chambers. Each of the two sealed chambers includes a front chamber member, a side chamber member, a rear chamber member, a plurality of speaker drivers, a plurality of side passive radiators, and at least one cabinet bracing. The cabinet bracing is secured in at least one corner formed by the front chamber member and one of the plurality of side cabinet members, the one of the plurality of side cabinet members and the rear chamber member, the rear chamber member and the side chamber member, and the side chamber member and the front chamber member. The cabinet bracing includes a cabinet bracing body and at least one stiffener attached to the cabinet bracing body. The portable instrument amplification system includes two front-facing ports comprising a rear port member between the two sealed chambers, behind the plurality of side passive radiators, and at least one port dividing member forming a bass phase plug vertically disposed between the plurality of side passive radiators of the two sealed chambers.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates front isometric view of a portable instrument amplification system 100 in accordance with one embodiment.

FIG. 1B illustrates top view of a portable instrument amplification system 100 in accordance with one embodiment.

FIG. 2A illustrates a portable instrument amplification system 200 in accordance with one embodiment.

FIG. 2B illustrates a portable instrument amplification system 200 in accordance with one embodiment.

FIG. 3 illustrates a portable instrument amplification system 300 in accordance with one embodiment.

FIG. 4A illustrates front view of a portable instrument amplification system 400 in accordance with one embodiment.

FIG. 4B illustrates a top view of a portable instrument amplification system 400 in accordance with one embodiment.

FIG. 5 illustrates a portable instrument amplification system 500 in accordance with one embodiment.

FIG. 6 illustrates a portable instrument amplification system 600 in accordance with one embodiment.

FIG. 7A illustrates a portable instrument amplification system 700 in accordance with one embodiment.

FIG. 7B illustrates a portable instrument amplification system 700 in accordance with one embodiment.

FIG. 8A illustrates a portable instrument amplification system 800 in accordance with one embodiment.

FIG. 8B illustrates a portable instrument amplification system 800 in accordance with one embodiment.

FIG. 8C illustrates a portable instrument amplification system 800 in accordance with one embodiment.

FIG. 8D illustrates a portable instrument amplification system 800 in accordance with one embodiment.

FIG. 9A illustrates a portable instrument amplification system sectional view 900 in accordance with one embodiment.

FIG. 9B illustrates a portable instrument amplification system sectional view 900 in accordance with one embodiment.

FIG. 9C illustrates a portable instrument amplification system sectional view 900 in accordance with one embodiment.

### DETAILED DESCRIPTION

The portable instrument amplification system is provided with a speaker cabinet construction that differs from the conventional constructions that are heavy and made with thick plywood or particle board with minimal bracing. Instead, the portable instrument amplification system employs a bracing technique that utilizes light plywood with thin braces of web and chord construction. These braces provide a dual function of acoustic dampening inside the cabinet as well as providing stiffening and strengthening to the cabinet. The result of the construction is a speaker cabinet with improved acoustical properties, which may be lighter and stronger than existing portable instrument amplification systems.

The portable instrument amplification system includes dual live arrays. The dual live arrays are two sets of four speakers aligned in vertical arrays that increase the throw and the output of the speaker, while also maximizing the dispersion horizontally. These arrays may be acoustically decoupled for maximum stereo effect from a single box.

The portable instrument amplification system includes multiple passive radiators. By using multiple radiators, the portable instrument amplification system maximizes the bass output and smooths the overall frequency response of the system.

The portable instrument amplification system includes port loaded radiators. Port loaded radiators are a new bass enhancement technique in portable instrument amplifications systems, allowing more deep bass out of a smaller enclosure than has been previously possible.

The portable instrument amplification system includes a bass phase plug that allows two bass ports to face each other and work together without acoustic cancelation issues.

The portable instrument amplification system includes a cabinet including a top cabinet member, a bottom cabinet member, and a plurality of side cabinet members. The portable instrument amplification system includes two sealed chambers, two front-facing ports, and an amplifier. Each of the sealed chambers comprises a front chamber member, a side chamber member, a rear chamber member, a plurality of speaker drivers mounted on the front chamber member, a plurality of side passive radiators mounted on the side chamber member, and a plurality of rear passive radiators mounted on the rear chamber member. The two front-facing ports comprise a first separator and a second separator that is vertical. The amplifier is electrically connected to the plurality of speaker drivers.

The first separator is vertically positioned between the two sealed chambers. The first separator is attached behind the plurality of side passive radiators in each side chamber member, to the top cabinet member, and to the bottom cabinet member. The first separator forms a rear chamber member sealing the plurality of side passive radiators from the amplifier, wherein the amplifier is mounted in a space behind the first separator. The second separator is vertically connected to the first separator, the top cabinet member, and the bottom cabinet member, thereby forming a bass phase plug between the plurality of side passive radiators of each sealed chamber.

The portable instrument amplification system includes a plurality of first cabinet bracings and a plurality of second cabinet bracings.

The plurality of first cabinet bracing is secured, inside each sealed chamber, to the rear chamber member, and to the side chamber member.

The plurality of second cabinet bracings are secured, inside each sealed chamber, to the front chamber member and one of the plurality of side cabinet members. They provide structural stiffening and acoustical damping.

Each of the first cabinet bracing and the second cabinet bracing includes a cabinet bracing body and a stiffener. The stiffener may be attached to the cabinet bracing body, wherein the first cabinet bracings and the second cabinet bracings are constructed using a web and chord method and provide stiffening to the cabinet and act as an acoustic dampener.

In some configurations, the plurality of speaker drivers is a line array.

In an embodiment, the portable instrument amplification system does not include rear passive radiators. Such a system includes a cabinet including a top cabinet member, a bottom cabinet member, and a plurality of side cabinet members. The portable instrument amplification system includes two sealed chambers where each sealed chamber includes a front chamber member, a side chamber member, a rear chamber member, a plurality of speaker drivers mounted on the front chamber member, and a plurality of side passive radiators mounted on the side chamber member. The portable instrument amplification system includes an amplifier. The amplifier is electrically connected to the plurality of speaker drivers. The portable instrument amplification system includes two front-facing ports comprising a first vertical separator and a second vertical separator. The first separator is vertically positioned between the two sealed chambers and attached behind the plurality of side passive radiators in each side chamber member, to the top cabinet member, and to the bottom cabinet member. The first separator forms a rear port member sealing the plurality of side passive radiators from the amplifier. The amplifier is mounted in a space behind the first separator. The second separator is vertically connected to the first separator, the top cabinet member, and the bottom cabinet member, thereby forming a bass phase plug between the plurality of side passive radiators of each sealed chamber. The portable instrument amplification system includes a plurality of first cabinet bracings and a plurality of second cabinet bracings. The plurality of first cabinet bracings is secured, inside each sealed chamber, to the rear chamber member and the side chamber member. The plurality of second cabinet bracing are secured, inside each sealed chamber, to the front chamber member, and to one of the plurality of side cabinet members. Each of the first cabinet bracings and the second cabinet bracings comprises a body and a stiffener. The stiffener is attached to the cabinet bracing body, where the first cabinet bracings and the second cabinet bracings are constructed using a web and chord method, provide stiffening to the cabinet, and act as an acoustic dampener.

In an embodiment, rear facing speakers may include woofers that are electrically connected to the amplifier. Such woofers may be mounted on the rear chamber members. In yet another embodiment, the rear chamber members do not have any mounted speaker drivers (i.e., no woofers or passive radiators).

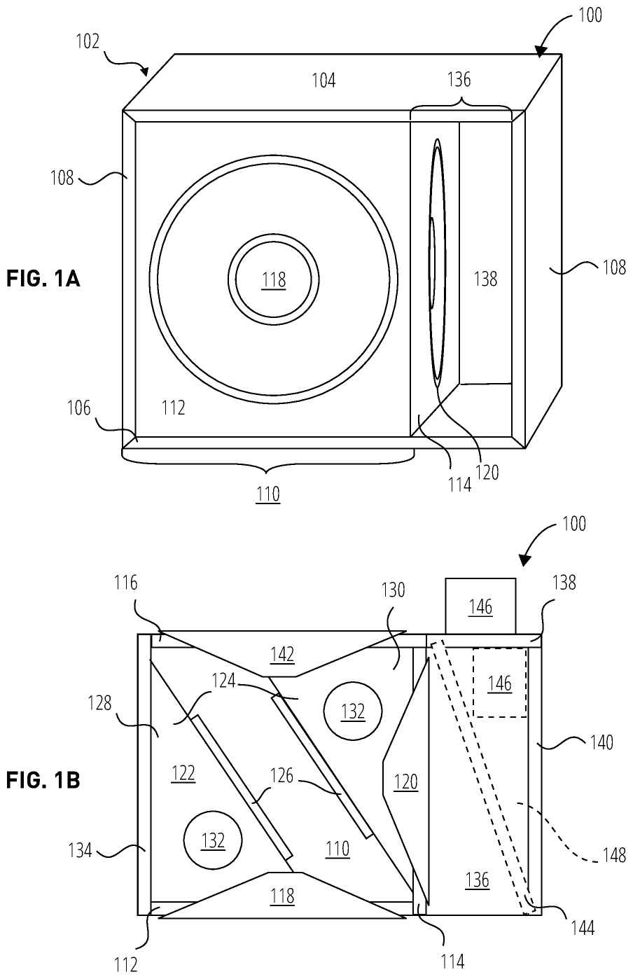

FIG. 1A and FIG. 1B illustrate a portable instrument amplification system 100 in accordance with one embodiment. FIG. 1A shows a front isometric external view, and FIG. 1B shows a top internal view. The portable instrument amplification system 100 may comprise a cabinet 102 including a top cabinet member 104, a bottom cabinet member 106, and a plurality of side cabinet members 108. The cabinet 102 and its members serve to provide structural support for the elements of the portable instrument amplification system 100, to protect internal components from damage, and to form portions of the compartments that control and amplify sound vibrations, as is well understood in the art of acoustic amplification.

The portable instrument amplification system 100 may further comprise a sealed chamber 110 comprising a front chamber member 112, a side chamber member 114, a rear chamber member 116, a rear speaker driver 308, a side passive radiator 120, and at least one cabinet bracing 122. As may be seen in the figures, the top cabinet member 104, bottom cabinet member 106, and one of the side cabinet members 108, in conjunction with the front chamber member 112, side chamber member 114, and rear chamber member 116, describe the six sides of space or chamber that may be sealed and supported to contain pressure waves generated by the action of the rear speaker driver 308. These pressure waves may act on the side passive radiator 120, leading it to propagate and amplify sound signals in the absence of the active electrical driving signals provided for the rear speaker driver 308. In some embodiments, the sealed chamber 110 may further include at least one rear passive radiator 142 in addition to the side passive radiator 120 for additional passive acoustic response.

The sealed chamber 110 may further comprise at least one cabinet bracing 122, comprising a cabinet bracing body 124 and a stiffener 126. The cabinet bracing 122 may be deployed between any two adjacent members forming the vertical sides of the sealed chamber 110. That is, the cabinet bracing 122 may connect the front chamber member 112 and one of the side cabinet members 108 (indicated as the first side cabinet member 134), the first side cabinet member 134 and the rear chamber member 116, the rear chamber member 116 and the side chamber member 114, or the side chamber member 114 and the front chamber member 112. In one embodiment, the sealed chamber 110 may include a first cabinet bracing 128 between the front chamber member 112 and the first side cabinet member 134, and a second cabinet bracing 130 between the rear chamber member 116 and the side chamber member 114, as shown in FIG. 1B. The cabinet bracing bodies 124 attached between two adjacent walls of the sealed chamber may provide structural support while allowing reduction of material width in all of the cabinet and sealed chamber members. The cabinet bracing 122, when connecting a member configured with a vibrating feature such as a rear speaker driver 308 and a side passive radiator 120, may act to prevent the member from flexing with the vibrations of the configured feature, and thus dissipating some of the vibrational energy before it may be projected as sound.

The stiffeners 126 may prevent flexing across the cabinet bracing bodies 124, improving their strength and stability. The stiffeners 126 may also act as baffles within the sealed chamber 110, breaking up the frequency response of the structure and thus preventing deleterious vibrational effects from harmonic resonances that may otherwise develop among the soundwaves propagated by the rear speaker driver 308 within the sealed chamber 110. These effects may over time negatively impact the structural integrity of the chamber and may in the near term degrade the acoustical response of the portable instrument amplification system 100, but may be prevented by the effect the stiffeners 126 may have of breaking up the airflow patterns within the sealed chamber 110. The cabinet bracings 122 may in one embodiment also include an aperture 132. The aperture 132 may allow the passage of wire for improved cable organization. The aperture 132 may further facilitate a reduction of material and therefore weight of the portable instrument amplification system without reducing the benefits to structural stability and improved vibration response provided by the cabinet bracing 122.

The portable instrument amplification system 100 may further comprise a front-facing port 136. The front-facing port 136 may include a rear port member 138 and the second side cabinet member 140, as shown. The second side cabinet member 140 may act an additional mechanical amplifier for the side passive radiator 120, directing the soundwaves generated by the side passive radiator 120 out and forward into an audience area along with those from the rear speaker driver 308. It may further act as a bass phase plug, helping to direct soundwaves in a manner that prevents interference near the side passive radiator 120 and thus allows more of the sound energy to project out and away from the portable instrument amplification system 100. In some embodiments, a standalone bass phase plug 144 may be deployed within the front-facing port 136 at an angle as shown in FIG. 1B. In this configuration, the angle of the standalone bass phase plug 144 may provide horn loading, further amplifying and directing the soundwaves away from the portable instrument amplification system 100 in the direction of an intended audience.

In one embodiment, the portable instrument amplification system 100 may further include an amplifier 146. The amplifier 146 may be attached to the exterior of the cabinet, so as not to take up any volume within the sealed chamber 110 or front-facing port 136 that may be needed to optimize acoustic performance. Where the members of the cabinet 102, sealed chamber 110, and front-facing port 136 permit, an amplifier chamber 148 may be configured among those members within the confines of the cabinet 102, in a space not occupied by the sealed chamber 110 and front-facing port 136. The amplifier 146 may then be mounted within the amplifier chamber 148, providing a more streamlined profile along the sides of the cabinet 102.

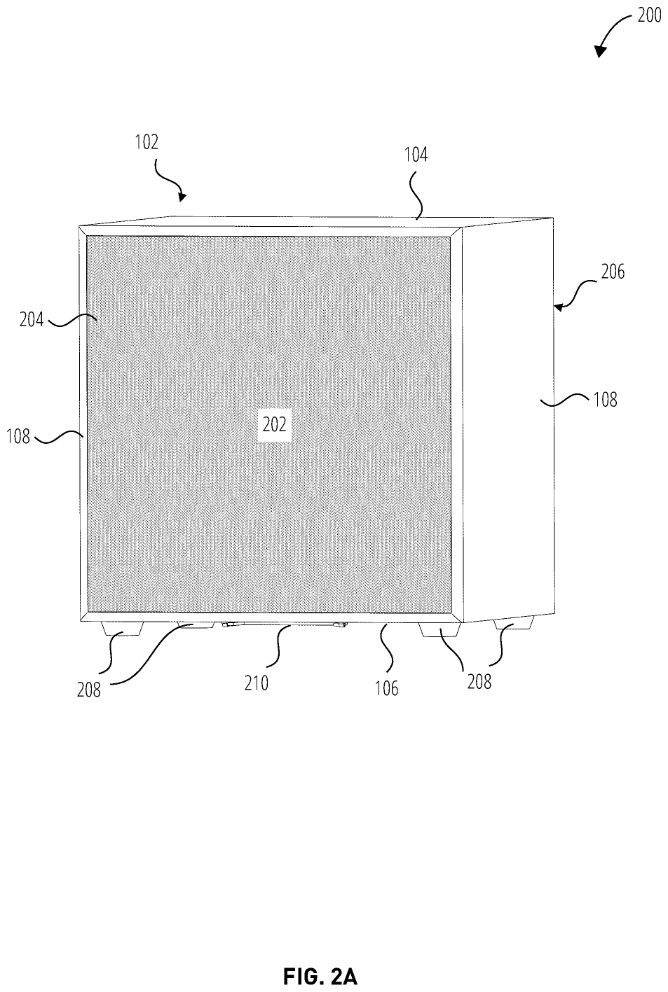

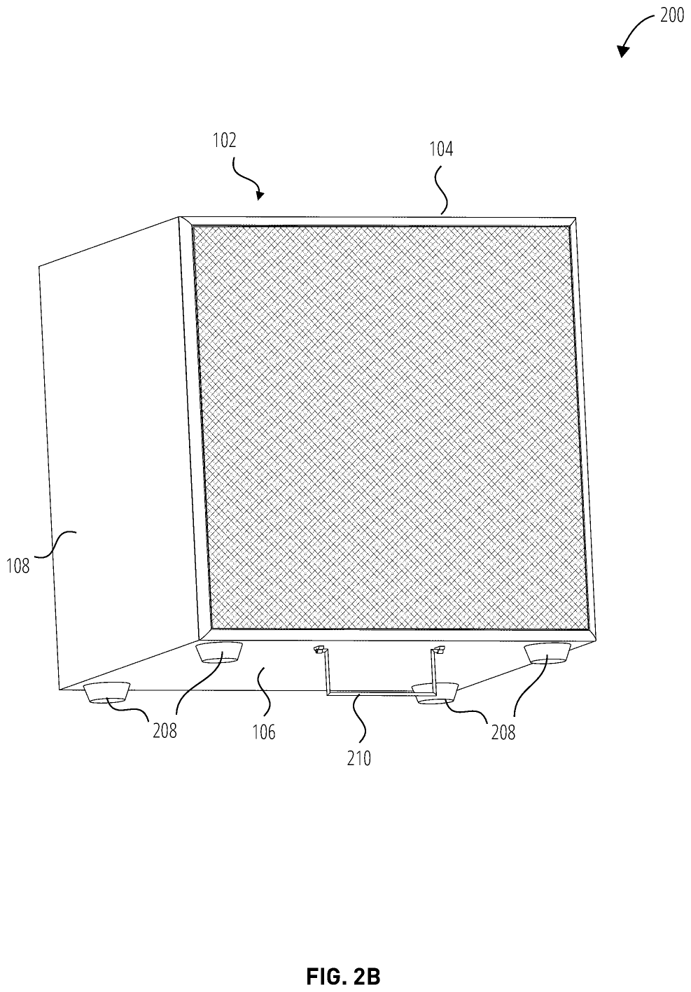

FIG. 2A and FIG. 2B illustrate a portable instrument amplification system 200 in accordance with one embodiment. The portable instrument amplification system 200 may comprise a cabinet 102 including a top cabinet member 104, a bottom cabinet member 106, and two side cabinet members 108. The portable instrument amplification system 200 may have a grill 202 installed on the front of the portable instrument amplification system 204 as shown. A grill 202 may also be installed on the rear of the portable instrument amplification system 206 (not shown) in some embodiments. The grills 202 may prevent dust and debris from entering the sealed chambers 110, front-facing ports 136, and other interior features introduced with respect to FIG. 1A and FIG. 1B. Likewise the grills 202 may prevent dust, debris, and damage to the rear speaker drivers 308, side passive radiators 120, and rear passive radiators 142 that the portable instrument amplification system 200 may be configured with.

The portable instrument amplification system 200 may further comprise isolating feet 208 and an adjustable riser 210. When the portable instrument amplification system 200 is placed on a floor, the isolating feet 208 may act to isolate the portable instrument amplification system 200 from the floor, such that the sound vibrations are transmitted through the air and not dissipated into the solid or carpeted (and therefore muffling) floor surface. These isolating feet 208 may further protect the cabinet 102 from scratches due to sliding along the floor and may absorb shock as the portable instrument amplification system 200 is placed on the ground. Over time such shock may have the effect of loosening the connections of the members with each other and of the cabinet bracing with the members, thus degrading the acoustic response and structural integrity of the portable instrument amplification system 200.

FIG. 2B provides a view of the portable instrument amplification system 200 in which the adjustable riser 210 has been positioned to angle the front of the portable instrument amplification system 204 up above an angle parallel with the floor on which the portable instrument amplification system 200 may be set. Such a position may improve sound projection from the portable instrument amplification system 200 to an audience area.

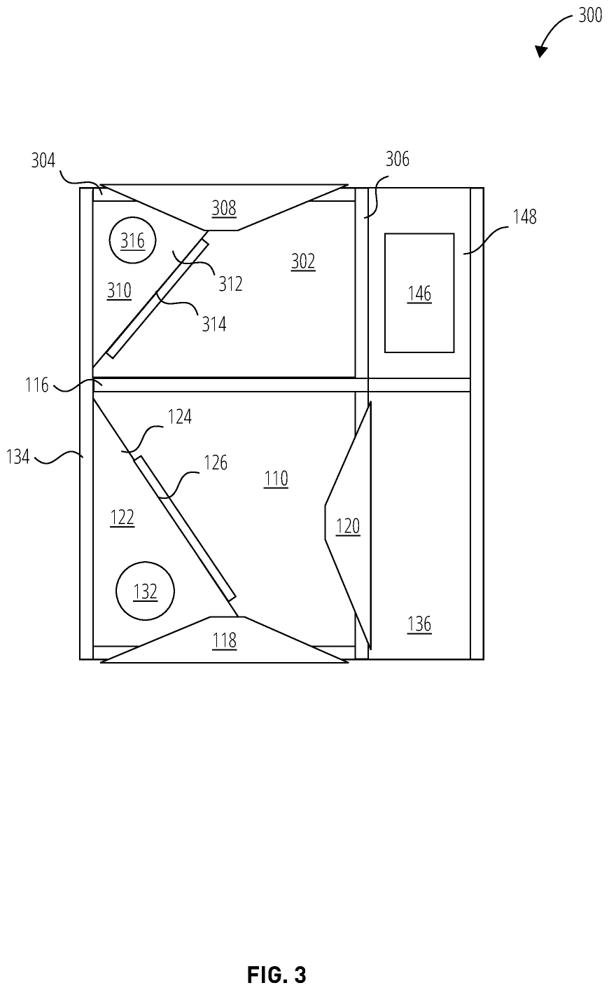

FIG. 3 illustrates a portable instrument amplification system 300 in accordance with one embodiment. Features shown such as the sealed chamber 110, rear chamber member 116, rear speaker driver 308, side passive radiator 120, cabinet bracing 122, cabinet bracing body 124, stiffener 126, first side cabinet member 134, front-facing port 136, amplifier 146, and amplifier chamber 148, are as introduced in FIG. 1A and FIG. 1B. In the configuration of FIG. 3, one cabinet bracing 122 has been shown with the sealed chamber 110, though in some embodiments additional cabinet bracings may be included.

The portable instrument amplification system 300 may further comprise a rear sealed chamber 302. The 302 may comprise a rear sealed chamber rear member 304, a rear sealed chamber side member 306, a rear speaker driver 308, a rear cabinet bracing 310, a rear cabinet bracing body 312, and a rear stiffener 314. The rear sealed chamber 302 and its rear speaker driver 308 may be incorporated to provide additional acoustic power and projection to the portable instrument amplification system 300, to provide a specific frequency range response, or to project sound both to the front and rear of the portable instrument amplification system 300 for a specific audience configuration.

The rear cabinet bracing 310 may include a rear cabinet bracing body 312 and rear stiffener 314 similar to the cabinet bracing 122, providing similar functionality. As is shown, each instance of cabinet bracing 122 and rear cabinet bracing 310 may be configured with a particular geometry, based on the dimensions of the sealed chamber 110 and rear sealed chamber 302, respectively, as well as the configuration of the rear speaker driver 308 and side passive radiator 120, and rear speaker driver 308, respectively. The rear cabinet bracing 310 may further include an aperture 316 to reduce material weight while maintaining the structural and acoustic benefit of the rear cabinet bracing 310.

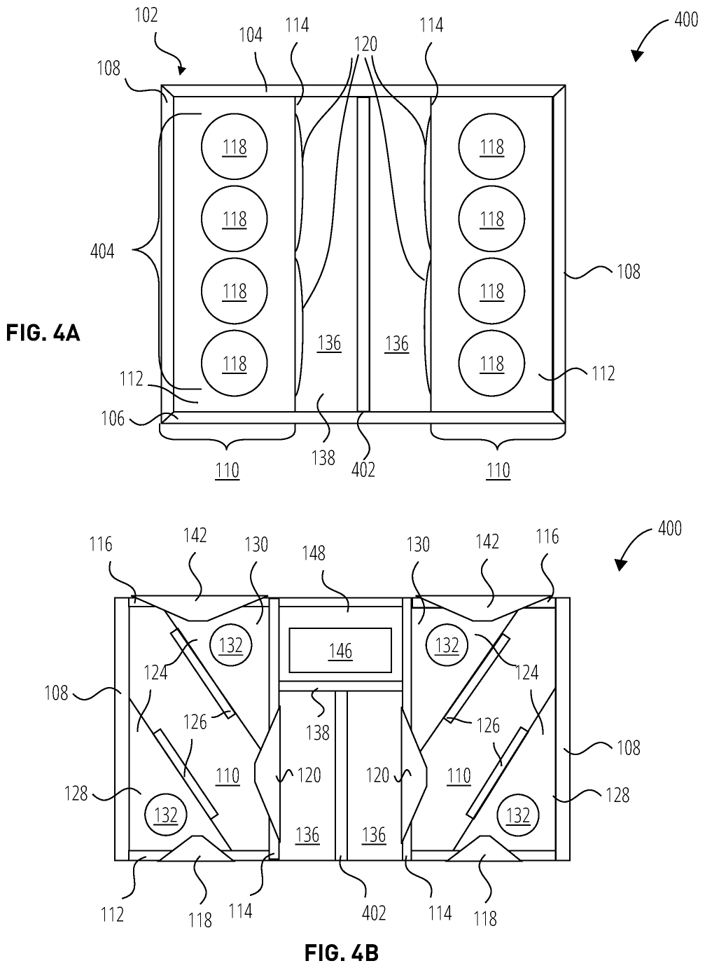

FIG. 4A and FIG. 4B illustrate a portable instrument amplification system 400 in accordance with one embodiment. FIG. 4A illustrates a front exterior view and FIG. 4B illustrates a top interior view. The portable instrument amplification system 400 may comprise a cabinet 102 including a top cabinet member 104, a bottom cabinet member 106, and two side cabinet members 108, as described with regard to FIG. 1A. The portable instrument amplification system 400 may contain two sealed chambers 110, each having a front chamber member 112, a side chamber member 114, and a rear chamber member 116, and each completely closed off through connection with the side cabinet members 108, the bottom cabinet member 106, and the top cabinet member 104, as shown.

The sealed chambers 110 may each further include a plurality of rear speaker drivers 308, such as the four rear speaker drivers 308 shown for each sealed chamber 110, and a plurality of side passive radiators 120, such as the two side passive radiators 120 shown for each. In some embodiments, the sealed chambers 110 may each comprise two rear passive radiators 142, which are shown in FIG. 4B. These may be disposed one above the other as shown for the side passive radiators 120.

The sealed chambers 110 may each further comprise cabinet bracings 122 comprising cabinet bracing bodies 124 and stiffeners 126. In one embodiment, these may include a first cabinet bracing 128 connected between the front chamber member 112 and side cabinet member 108 and a second cabinet bracing 130 connected between the rear chamber member 116 and the side chamber member 114. In some embodiments, the cabinet bracings 122 further comprise an aperture 132, as shown, to reduce material weight without impacting structural and vibrational support. In a configuration such as that illustrated, with four rear speaker drivers 308, two side passive radiators 120, and in some embodiments two rear passive radiators 142, each sealed chamber 110 may comprise three first cabinet bracings 128, attached to the front chamber member 112 between each pair of rear speaker drivers 308, and one second cabinet bracing 130, attached to the side chamber member between the pair of side passive radiators 120 and to the rear chamber member 116 between the pair of rear passive radiators 142. This configuration is presented as an example and is not intended to limit the scope of this disclosure with regard to the cabinet bracing claimed.

The portable instrument amplification system 400 may further comprise two front-facing ports 136. The front-facing ports 136 may comprise a rear port member 138 attached vertically behind the side passive radiators 120, and at least one port dividing member and bass phase plug 402, attached vertically between the side passive radiators 120 of each sealed chamber 110, as shown. The front-facing ports 136 in this configuration provide functionality similar to that described with respect to FIG. 1A and FIG. 1B, in amplifying and directing sound projected by the side passive radiators 120. In addition, in a configuration such as that illustrated in FIG. 4A and FIG. 4B with the side passive radiators 120 of each sealed chamber 110 facing each other, the port dividing member and bass phase plug 402 prevents the sound waves projected from each set of side passive radiator 120 from interfering with the sound waves projected from the other. Such interference may degrade the gain performance of the portable instrument amplification system 400 but may be prevented from doing so by the disposition of the port dividing member and bass phase plug 402 between the two front-facing ports 136.

In one embodiment, the space formed by the rear port member 138 and the side chamber members 114 of the sealed chambers 110 may be used as an amplifier chamber 148 and may house an amplifier 146 electrically connected to the rear speaker drivers 308 of both sealed chambers 110. In one embodiment, the plurality of rear speaker drivers 308 of each sealed chamber 110 may be configured in a line array 404 as illustrated. In a line array 404, all of the rear speaker drivers 308 in the line array 404 are arranged along a single, common center line. In one embodiment, the rear speaker drivers 308 may all be connected in series. In on embodiment, the top pair of rear speaker drivers 308 may be connected in series and the bottom pair also connected in series. The two series pairs may be further connected to each other in parallel. In one embodiment, each rear speaker driver 308 may have an individual connection to the amplifier 146. These configurations are presented as examples. Other configurations are possible within the scope of this disclosure.

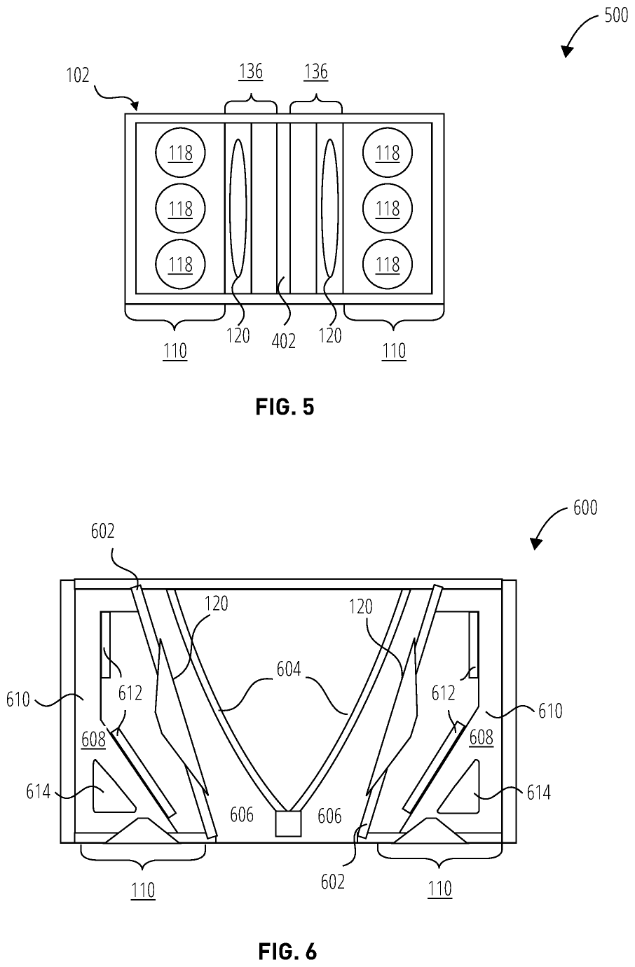

FIG. 5 illustrates a portable instrument amplification system 500 in accordance with one embodiment. The portable instrument amplification system 500 may comprise a cabinet 102, sealed chambers 110, rear speaker drivers 308, side passive radiators 120, front-facing ports 136, and a port dividing member and bass phase plug 402, as previously introduced. The portable instrument amplification system 500 may be a smaller version of the portable instrument amplification system disclosed than the portable instrument amplification system 400, and larger than the portable instrument amplification system 100. The basic components shown here may be arranged in multiple configurations to achieve a range of portable instrument amplification systems providing different levels of audio gain, frequency performance, and portability, as desired by a user. Different sizes and types of rear speaker driver 308 and side passive radiators 120 may be used to provide additional flexibility in size, performance, and cost.

FIG. 6 illustrates a portable instrument amplification system 600 in accordance with one embodiment. The sealed chambers 110 may be configured with angled members, such as the angled side chamber members 602 shown. The angled side chamber members 602 may allow the side passive radiators 120 of each sealed chamber 110 to be configured at a particular facing angle to a port dividing member and bass phase plug 604 also disposed at an angle and having a curvature configured to provide a horn loaded front-facing port 606 for each side passive radiator 120. A configuration such as that illustrated may exhibit significant gain improvements in a bass frequency range over the orthogonally disposed front-facing port 136 previously described.

In addition to the angled side chamber member 602 modification, a sealed chamber 110 may also incorporate a cabinet bracing 608 configuration other than that illustrated previously. Rather than configuring a triangular cabinet bracing body with a single stiffener as shown for cabinet bracing 122 illustrated previously, cabinet bracing 608 may employ a cabinet bracing body 610 shaped to connect more than two adjacent sides, providing greater stability. Multiple stiffeners 612 may be provided to each cabinet bracing body 610 to provide the stiffening needed against vibration and flexing of the cabinet bracing body 610. In one embodiment, the cabinet bracings 608 may further comprise apertures 614. The apertures 614 may allow material to be removed and weight reduced without reducing the added structural and vibrational benefits of the cabinet bracing 608. Circular apertures have been illustrated previously, and the apertures 614 of FIG. 6 are shown as triangular, following the contours of the cabinet bracing bodies 610. The cabinet bracing apertures may be of any size and shape that allows the removal of material without impacting the strength of the cabinet bracing.

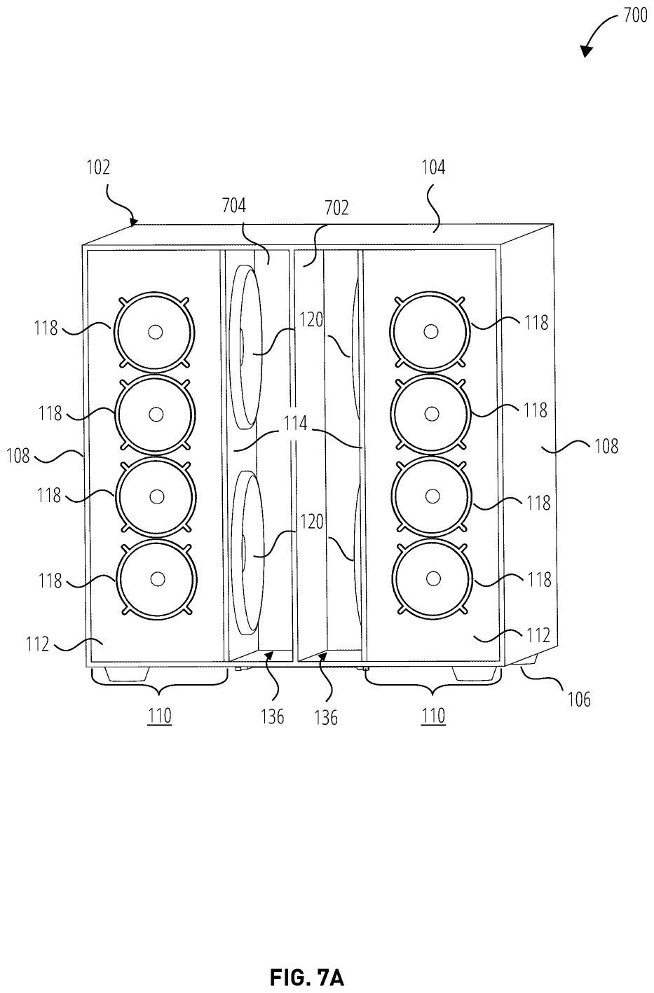

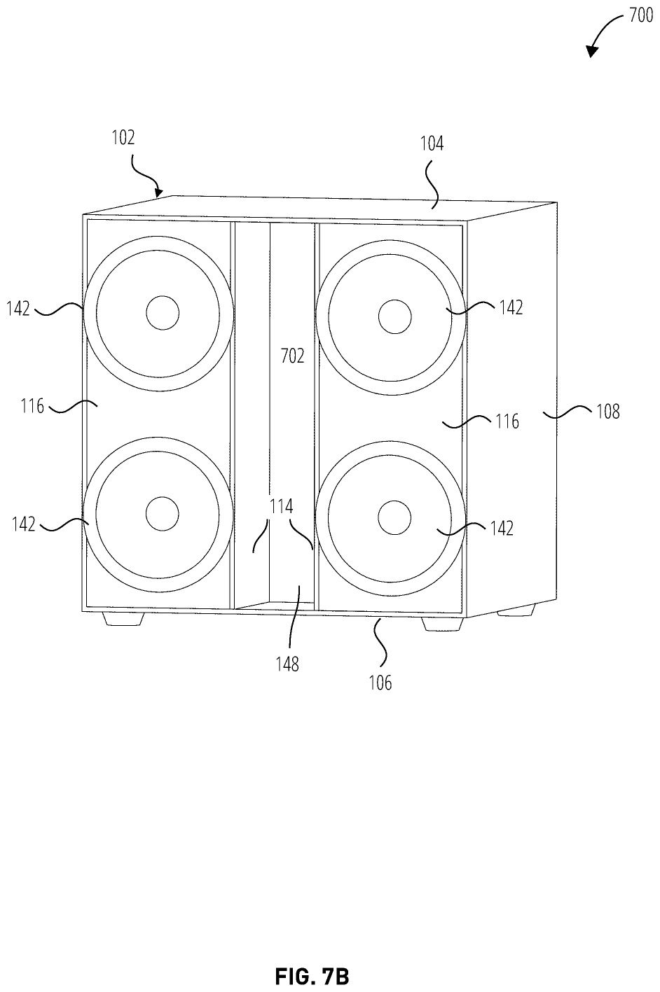

FIG. 7A and FIG. 7B illustrate exterior front and rear views, respectively, of a portable instrument amplification system 700 in accordance with one embodiment. As shown in FIG. 7A, two sealed chambers 110 may each comprise a front chamber member 112, a side chamber member 114, a rear chamber member (seen in FIG. 7B), and a plurality of speaker drivers 118 mounted on the front chamber member 112. Additionally, each sealed chamber 110 may comprise a plurality of side passive radiators 120 mounted on the side chamber member 114.

The portable instrument amplification system 700 may comprise two front-facing ports 136 adjacent to the sealed chambers 110. The front-facing ports 136 may comprise a first separator 702 and a second separator 704. The first separator 702 may be vertically positioned between the two sealed chambers (sealed chamber 110 and sealed chamber 110). The second separator 704 may thus act as a port dividing member and a bass phase plug. The second separator 704 may be attached to the top cabinet member 104 and bottom cabinet member 106 behind the plurality of side passive radiators in each side chamber member 114. The first second separator 704 attached thus forms a rear port member and may seal the plurality of side passive radiators 120 from an amplifier chamber 148, as seen in FIG. 7B. An amplifier may be mounted in the amplifier chamber 148 space behind the first separator 702.

FIG. 7B illustrates the rear of a portable instrument amplification system 700, showing the rear chamber members 116 of each sealed chamber 110. In one embodiment, each rear chamber member 116 may have rear passive radiators 142 mounted therein. A space between the sealed chambers 110 may in some embodiments act as an amplifier chamber 148.

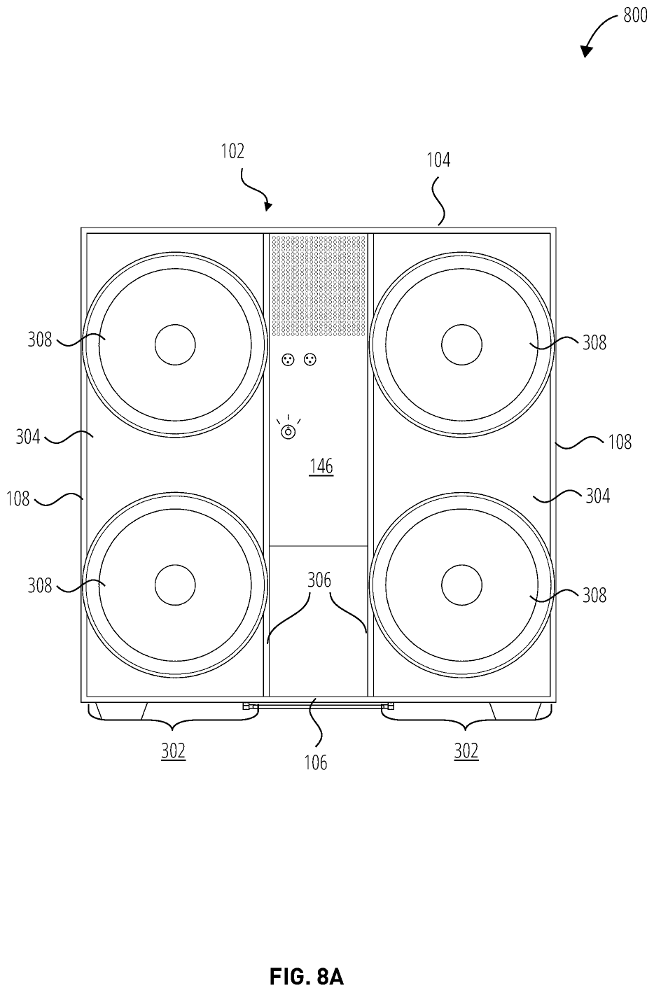

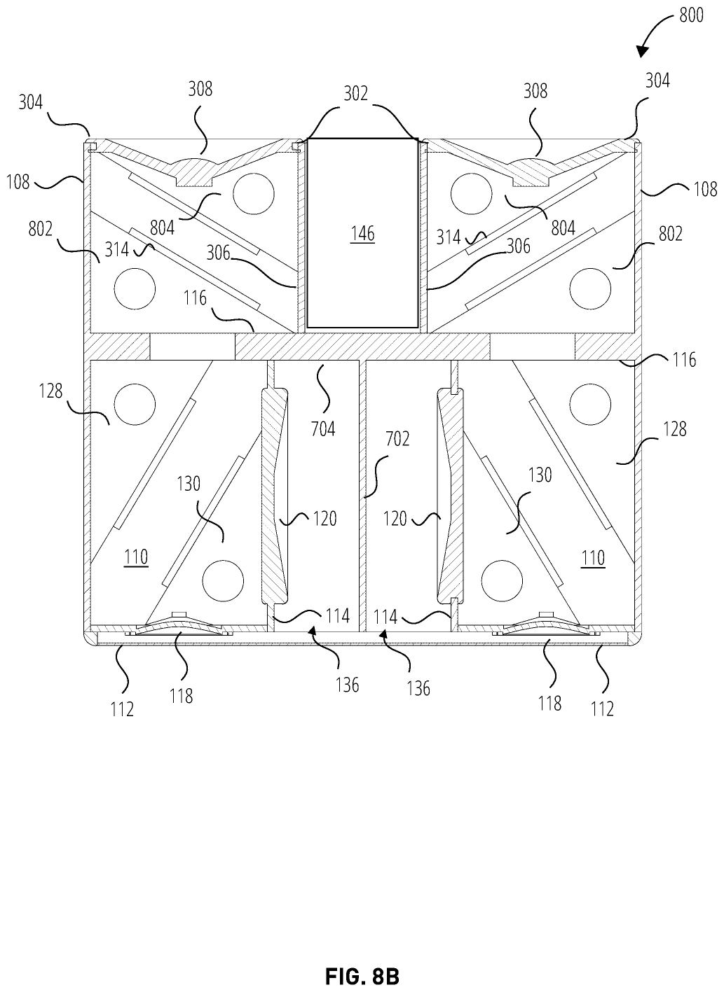

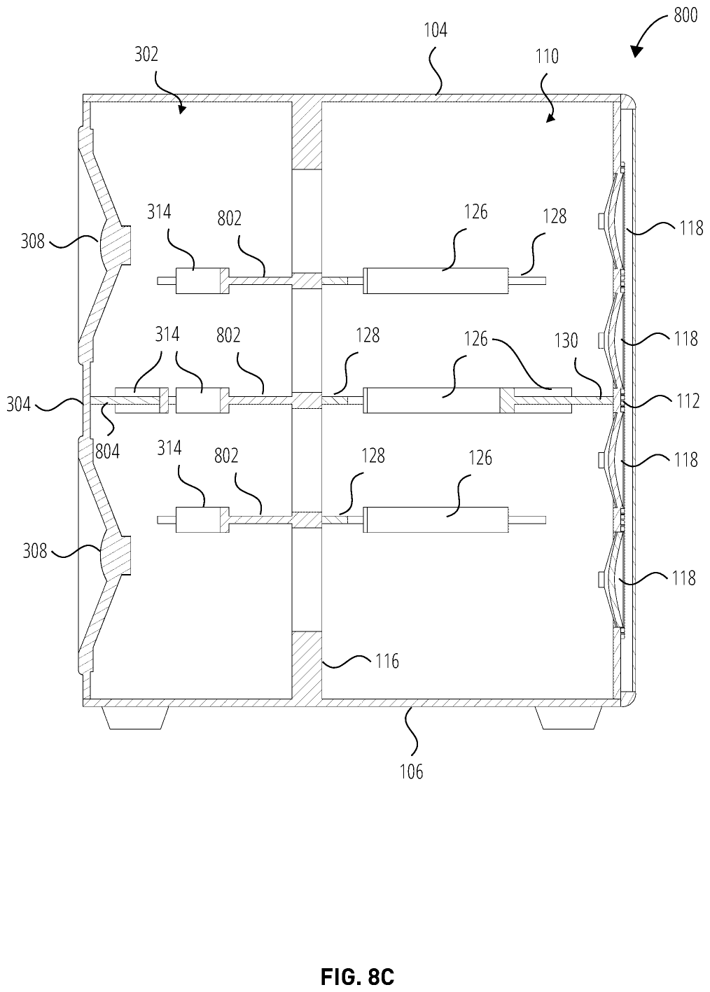

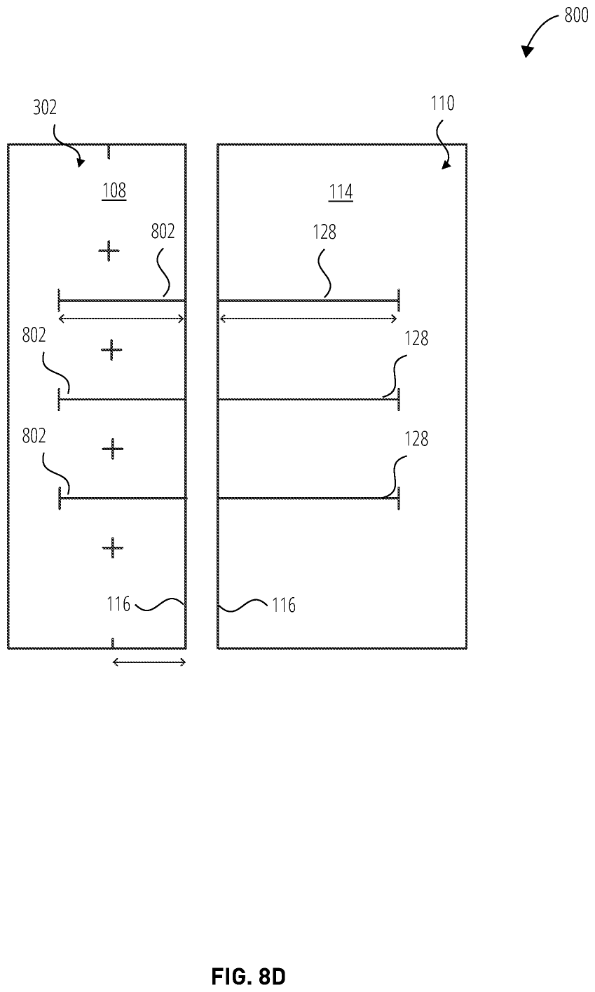

FIG. 8A through FIG. 8D illustrate a portable instrument amplification system 800 in accordance with one embodiment. The portable instrument amplification system 800 may incorporate rear sealed chambers as introduced with respect to FIG. 3. FIG. 8A shows a rear exterior view of the portable instrument amplification system 800. In addition to the elements previously described with respect to FIG. 7A, the portable instrument amplification system 800 may comprise rear sealed chambers 302 instead of rear passive radiators 142, as introduced with respect to FIG. 3. The rear sealed chambers 302 may comprise rear sealed chamber rear members 304, rear sealed chamber side members 306, and rear speaker drivers 308. An amplifier 146 may be mounted proximally to the rear sealed chambers 302. The amplifier 146 may be electrically connected to a plurality of speaker drivers, including the rear speaker drivers 308.

FIG. 8B illustrates a top interior view of the portable instrument amplification system 800. As described for other embodiments, sealed chambers 110 comprising, among other features, speaker drivers 118, side passive radiators 120, first cabinet bracings 128, and second cabinet bracings 130, may be configured within the cabinet of the portable instrument amplification system 800. Rear chamber members 116 of the sealed chambers 110 may also constitute a side of each rear sealed chamber 302, as shown, along with the side cabinet members 108, rear sealed chamber rear members 304, and rear sealed chamber side members 306. The rear sealed chambers 302 may further comprise rear speaker drivers 308.

Front-facing ports 136 may be formed as shown by the sealed chambers 110, a first separator 702, and a second separator 704. The second separator 704 may be vertically connected to the first separator 702, the top cabinet member 104, and the bottom cabinet member 106. The positioning of the second separator 704 may form a bass phase plug between the plurality of side passive radiators 120 of each sealed chamber.

Each sealed chamber 110 may further comprises a plurality of first cabinet bracings 128 and a second cabinet bracing 130. The first cabinet bracings 128 may be secured, inside each sealed chamber 110, to the rear chamber member 116, and to the side cabinet member 108. The second cabinet bracing 130 may be secured, inside each sealed chamber 110, to the front chamber member 112 and the side chamber member 114. Each first cabinet bracing 128 and second cabinet bracing 130 may comprises a cabinet bracing body and a stiffener 126. The stiffener 126 may be attached to the cabinet bracing body. Thus, the plurality of first cabinet bracings 128 and the second cabinet bracing of each sealed chamber 110 may provide structural stiffening and acoustical damping through a web and chord construction.

Similarly, the rear sealed chambers 302 may comprise a plurality of first rear cabinet bracings 802 and a second rear cabinet bracing. In one embodiment, the first rear cabinet bracings 802 of each rear sealed chamber 302 may be secured to the rear chamber member 116 of the adjacent sealed chamber 110 and a side cabinet member 108. The second rear cabinet bracing 804 may be secured to the rear sealed chamber rear member 304 and the rear sealed chamber side member 306. Each first rear cabinet bracing 802 and the second rear cabinet bracing 804 may comprise a rear cabinet bracing body and a rear stiffener 314. The first rear cabinet bracings 802 and second rear cabinet bracings 804 may be constructed using a web and chord method, provide stiffening to the cabinet, and act as an acoustic dampener.

FIG. 8C illustrates a side interior view of a sealed chamber 110 and a rear sealed chamber 302 of a portable instrument amplification system 800. Three first cabinet bracings 128 are shown for the sealed chamber 110, positioned between the four speaker drivers 118 mounted in the front chamber member 112. One second cabinet bracing 130 may be seen mounted at a vertical halfway point within the sealed chamber 110. This side view of the stiffeners 126 illustrates how they may act as baffles due to their vertical height within the 110.

Similarly, three first rear cabinet bracings 802 may be seen in the rear sealed chamber 302, mounted at the same vertical positions as the first cabinet bracings 128 in this embodiment. A second rear cabinet bracing 804 is also shown, mounted at a vertical halfway point that positions the second rear cabinet bracing 804 between the two rear speaker drivers 308. The rear stiffeners 314 may act as baffles similarly to the stiffeners 126.

FIG. 8D illustrates a schematic for cabinet bracing attachments of the portable instrument amplification system. The details are shown for the portable instrument amplification system 800 regarding the positioning of the sealed chamber 110 and the rear sealed chamber 302, as well as the orientation of the first cabinet bracing 128 and the first rear cabinet bracing 802 on the rear chamber member 116 that separates them.

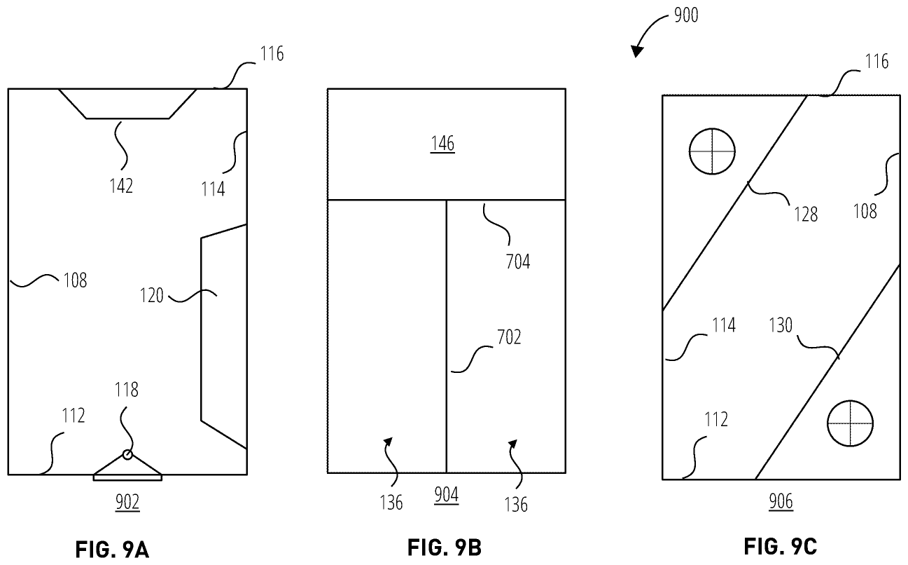

FIG. 9A-FIG. 9C illustrate top schematic views of the portable instrument amplification system. FIG. 9A illustrates a top sectional view 902 of one of the sealed chambers of the cabinet with the positioning of the rear passive radiators 142, the side passive radiators 120 and the speaker drivers 118. The rear passive radiators 142 are mounted on the rear chamber member 116. The side passive radiators 120 are mounted on the side chamber member 114. The speaker drivers 118 are mounted to the front chamber member 112.

FIG. 9B illustrates a top sectional view 904 of the front-facing port 136 showing the positioning of the first separator 702, the second separator 704, and the amplifier 146.

FIG. 9C illustrates a top sectional view 906 of a sealed chamber showing the positioning of the first cabinet bracing 128 and the second cabinet bracing 130. The plurality of a first cabinet bracing are secured, inside each of the sealed chambers, to the rear chamber member 116, and the side chamber member 114. The plurality of a second cabinet bracing 130 are secured, inside each of the sealed chambers, to the front chamber member 112 and one of the side cabinet member 108.

### LISTING OF DRAWING ELEMENTS

100 portable instrument amplification system

102 cabinet

104 top cabinet member

106 bottom cabinet member

108 side cabinet member

110 sealed chamber

112 front chamber member

114 side chamber member

116 rear chamber member

118 speaker driver

120 side passive radiator

122 cabinet bracing

124 cabinet bracing body

126 stiffener

128 first cabinet bracing

130 second cabinet bracing

132 aperture

134 first side cabinet member

136 front-facing port

138 rear port member

140 second side cabinet member

142 rear passive radiator

144 standalone bass phase plug

146 amplifier

148 amplifier chamber

200 portable instrument amplification system

202 grill

204 front of the portable instrument amplification system

206 rear of the portable instrument amplification system

208 isolating foot

210 adjustable riser

300 portable instrument amplification system

302 rear sealed chamber

304 rear sealed chamber rear member

306 rear sealed chamber side member

308 rear speaker driver

310 rear cabinet bracing

312 rear cabinet bracing body

314 rear stiffener

316 aperture

400 portable instrument amplification system

402 port dividing member and bass phase plug

404 line array

500 portable instrument amplification system

600 portable instrument amplification system

602 angled side chamber member

604 port dividing member and bass phase plug

606 horn loaded front-facing port

608 cabinet bracing

610 cabinet bracing body

612 stiffener

614 aperture

700 portable instrument amplification system

702 first separator

704 second separator

800 portable instrument amplification system

802 first rear cabinet bracing

804 second rear cabinet bracing

900 portable instrument amplification system sectional view

902 top sectional view

904 top sectional view

906 top sectional view

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.0 § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the disclosure as claimed. The scope of disclosed subject matter is not limited to the depicted embodiments but is rather set forth in the following claims.

What is claimed is:

1. A portable instrument amplification system comprising:
a cabinet including a top cabinet member, a bottom cabinet member, and a plurality of side cabinet members;
at least one sealed chamber, the sealed chamber comprising:
a front chamber member;
a side chamber member;
a rear chamber member;
at least one speaker driver; and
at least one side passive radiator; and
at least one cabinet bracing secured in at least one corner formed by at least one of:
the front chamber member and a first side cabinet member;
the first side cabinet member and the rear chamber member;
the rear chamber member and the side chamber member; and
the side chamber member and the front chamber member,
wherein the at least one cabinet bracing comprises:
a cabinet bracing body; and
at least one stiffener attached to the cabinet bracing body; and
at least one front-facing port comprising:
a rear port member vertically attached between the side chamber member and a second side cabinet member behind the at least one side passive radiator; and
at least one bass phase plug vertically disposed facing the at least one side passive radiator, wherein the at least one bass phase plug comprises one of the second side cabinet member and a standalone bass phase plug.

2. The portable instrument amplification system of claim 1, the sealed chamber further comprising at least one rear passive radiator.

3. The portable instrument amplification system of claim 1, the cabinet bracing body further comprising an aperture.

4. The portable instrument amplification system of claim 1, wherein the sealed chamber comprises two cabinet bracings, the two cabinet bracings comprising a first cabinet bracing secured between the front chamber member and the first side cabinet member and a second cabinet bracing secured between the rear chamber member and the side chamber member.

5. The portable instrument amplification system of claim 1, further comprising an amplifier electrically connected to the at least one speaker driver.

6. The portable instrument amplification system of claim 5, wherein the amplifier is mounted external to the cabinet.

7. The portable instrument amplification system of claim 5, wherein the amplifier is disposed in an amplifier chamber within the cabinet, the amplifier chamber comprising a space not occupied by the at least one sealed chamber and the at least one front-facing port.

8. The portable instrument amplification system of claim 1, further comprising at least one grill, the at least one grill protecting at least one of a front of the portable instrument amplification system and a rear of the portable instrument amplification system from dust and debris.

9. The portable instrument amplification system of claim 1, further comprising at least one of:
a plurality of isolating foot attached to the bottom cabinet member; and
an adjustable riser attached to the bottom cabinet member, wherein the adjustable riser supports the portable instrument amplification system in a position at an angle with a floor on which the portable instrument amplification system is placed.

10. The portable instrument amplification system of claim 1, further comprising at least one rear sealed chamber, the at least one rear sealed chamber comprising:
a rear sealed chamber rear member;
a rear sealed chamber side member;
at least one rear speaker driver; and
at least one rear cabinet bracing, secured in at least one corner formed by at least one of:
the rear chamber member and the first side cabinet members;
the first side cabinet members and the rear sealed chamber rear member;
the rear sealed chamber rear member and the rear sealed chamber side member; and
the rear sealed chamber side member and the rear chamber member, wherein the at least one rear cabinet bracing comprises:
a rear cabinet bracing body; and
at least one rear stiffener attached to the rear cabinet bracing body.

11. A portable instrument amplification system comprising:
a cabinet including a top cabinet member, a bottom cabinet member, and a plurality of side cabinet members;
two sealed chambers, each of the two sealed chambers comprising:
a front chamber member;
a side chamber member;
a rear chamber member;
a plurality of speaker drivers;
a plurality of side passive radiators; and
at least one cabinet bracing secured in at least one corner formed by at least one of:
the front chamber member and one of the plurality of side cabinet members;
the one of the plurality of side cabinet members and the rear chamber member;
the rear chamber member and the side chamber member; and
the side chamber member and the front chamber member,
wherein the at least one cabinet bracing comprises:
a cabinet bracing body; and
at least one stiffener attached to the cabinet bracing body; and
two front-facing ports comprising:
a rear port member between the two sealed chambers, behind the plurality of side passive radiators; and
at least one port dividing member forming a bass phase plug vertically disposed between the plurality of side passive radiators of the two sealed chambers.

12. The portable instrument amplification system of claim 11, wherein the plurality of speaker drivers is configured in a line array.

13. The portable instrument amplification system of claim 11, each of the sealed chambers further comprising a plurality of rear passive radiators.

14. The portable instrument amplification system of claim 11, the cabinet bracing body further comprising an aperture.

15. The portable instrument amplification system of claim 11, wherein each of the sealed chambers comprises two cabinet bracings, the two cabinet bracings comprising a first cabinet bracing secured between the front chamber member and the first side cabinet member and a second cabinet bracing secured between the rear chamber member and the side chamber member.

16. The portable instrument amplification system of claim 11, further comprising an amplifier electrically connected to the plurality of speaker drivers.

17. The portable instrument amplification system of claim 16, wherein the amplifier is mounted external to the cabinet.

18. The portable instrument amplification system of claim 16, wherein the amplifier is disposed in an amplifier chamber within the cabinet, the amplifier chamber comprising a space not occupied by the two sealed chambers and the two front-facing ports.

19. The portable instrument amplification system of claim 11, further comprising at least one grill, the at least one grill protecting at least one of a front of the portable instrument amplification system and a rear of the portable instrument amplification system from dust and debris.

20. The portable instrument amplification system of claim 11, further comprising at least one of:
a plurality of isolating foot attached to the bottom cabinet member; and
an adjustable riser attached to the bottom cabinet member, wherein the adjustable riser supports the portable instrument amplification system in a position at an angle with a floor on which the portable instrument amplification system is placed.
